(19) United States
(12) Patent Application Publication
(10) Pub. No.: US 2008/0241525 A1
(43) Pub. Date: Oct. 2, 2008

(54) STAMPER FOR OPTICAL INFORMATION RECORDING MEDIUM, MASTER FOR MAGNETIC TRANSFER, AND MANUFACTURING METHODS THEREOF

(75) Inventor: Seiji KASAHARA, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/059,962

(22) Filed: Mar. 31, 2008

(30) Foreign Application Priority Data
Mar. 29, 2007 (JP) 2007-089801

(51) Int. Cl. C23C 22/78; B32B 5/00

(52) U.S. Cl. 428/336; 205/183

(57) ABSTRACT

A method of manufacturing a stamper for an optical information recording medium comprises the steps of: preparing a mother stamper having a surface layer in which a grooved pattern is formed; forming a conductive layer on the mother stamper; and forming an electroplating layer on the conductive layer by electroplating the mother stamper in a plating solution consisting mainly of nickel sulfamate. In this method, a current density is increased at a predetermined increasing rate at a start of electroplating.

### CROSS REFERENCE TO RELATED APPLICATIONS

This application claims the foreign priority benefit under Title 35, United States Code, §119(a)-(d) of Japanese Patent Application No. 2007-089801 filed on Mar. 29, 2007 in the Japan Patent Office, the disclosure of which is herein incorporated by reference in its entirety.

### BACKGROUND OF THE INVENTION

The present invention relates to a method of manufacturing a stamper for an optical information recording medium having grooved patterns on the surface, and a stamper for an optical information recording medium (hereinafter also simply referred to as a “stamper”) manufactured by this method. The present invention also relates to a method of manufacturing a master for magnetic transfer having grooved patterns on the surface, and a master for magnetic transfer manufactured by this method.

In accordance with a requirement for high recording density, development have been carried out in recent years for optical information recording media with high recording density, which are to be recorded and/or read by using a laser light having a wavelength not more than 450 nm. An optical information recording medium for write-once with high recording density is manufactured by providing a recording layer containing, for example, a dye onto a resin-made disc-shaped substrate in which a pre-groove (fine grooved pattern) is formed for tracking of the laser light, followed by attaching a substrate for the protection of the dye containing layer. The resin substrate is manufactured by injection molding, during which a resin material is injection molded using a metal stamper having a reversely formed fine grooved pattern as a part of a pair of molds.

This stamper is repeatedly used for molding a plurality of resin-made substrates having a fine grooved pattern. For this reason, it is necessary to ensure durability of the stamper at the surface where the grooved pattern has been formed. To overcome this problem, conventionally, the following two techniques have been proposed.

Japanese Laid-open Patent Application No. 2002-97536 (see paragraph [0016]) discloses that a Ni-based alloy selectively containing one of Mo, Co, Cr, and Fe is used as a material for the stamper in order to improve the durability of the stamper. According to this technique, the Ni-based alloy is vacuum melted and the obtained molten metal is cast into a mold. The resulting ingot is then subject to heat treatment, hot forging, hot rolling, and cold rolling to manufacture the stamper.

Japanese Laid-open Patent Application No. 2006-120230 (see paragraphs [0022] to [0024]) which corresponds to US 2007/0126136 A1 discloses as a material for the stamper a composite material consisting of Ni and other materials (e.g., polyimide; hereinafter also referred to as “impurities”), and a Ni-containing material in which a plurality of fine voids are dispersed in order to improve heat insulating properties and durability. In this technique, the stamper is produced by electroforming (electroplating) using an electrolyte solution containing Ni and impurities.

However, the former technique disclosed in Japanese Laid-open Patent Application No. 2002-97536 has a drawback that the ingot cast from the Ni-based material requires a plurality of treatments, leading to complicated manufacturing process of the stamper. In the case where the stamper is produced by electroforming using an electrolyte solution containing Ni, Mo, etc., it is expected that the content adjustment for each component such as Ni and Mo will be very difficult.

Meanwhile, the latter technique disclosed in Japanese Laid-open Patent Application No. 2006-120230 has a drawback that in the case where the composite material is used as the material for the stamper, it is expected that the content adjustment for each component such as Ni and polyimide will be very difficult. This is because the stamper is produced by electroforming using an electrolyte solution containing Ni and impurities. In the case where the Ni-based material in which a plurality of fine voids are dispersed is used as the material for the stamper, it is difficult to control stress that is generated due to the fine voids. In other words, it is difficult to provide a balanced stress distribution in the stamper.

These drawbacks also occur in a master for magnetic transfer having a similar fine grooved pattern as with the stamper.

In view of the foregoing drawbacks of the conventional techniques, an object of the present invention is to provide manufacturing methods for a stamper and a master for magnetic transfer, which can be readily manufactured while improving durability, as well as to provide a stamper and a master for magnetic transfer, which can be produced by these methods.

### SUMMARY OF THE INVENTION

According to a first aspect of the present invention, there is provided a method of manufacturing a stamper for an optical information recording medium, comprising the steps of preparing a mother stamper having a surface layer in which a grooved pattern is formed, forming a conductive layer on the mother stamper, and forming an electroplating layer on the conductive layer by electroplating the mother stamper in a plating solution consisting mainly of nickel sulfamate. In this manufacturing method, a current density is increased at a predetermined increasing rate at a start of electroplating.

According to the present invention, if the current density increases at a predetermined increasing rate at the start of electroplating, the Ni content in the electroplating layer continuously increases from the surface of the electroplating layer adjacent to the conductive layer toward the inner part of the electroplating layer. As a result, the content of other elements (impurities) except for Ni becomes higher at the surface layer of the electroplating layer that is adjacent to the conductive layer, which leads to improved durability of the surface layer. This fact has been proved through experiments carried out by the inventor.

It is preferable that the predetermined increasing rate is determined to have a slope such that an average current density from the start of the electroplating until elapse of 25 minutes is in a range of 1.9 to 5.0 A/dm². This makes it possible to accurately form the surface layer of the electroplating layer adjacent to the conductive layer.

In addition to the above condition, it is preferable that the predetermined increasing rate is determined to have a slope such that an average current density from the start of the electroplating until elapse of 50 minutes is in a range of 3.4 to 10 A/dm², an average current density from the start of the electroplating until elapse of 75 minutes is in a range of 4.0 to 13.5 A/dm², and an average current density from the start of the electroplating until elapse of 100 minutes is in a range of 4.3 to 14.5 A/dm². This makes it possible to highly accurately form the surface layer of the electroplating layer adjacent to the conductive layer as well as to improve the productivity.

According to a second aspect of the present invention, there is provided a stamper for an optical information recording medium, which is manufactured by the process comprising the steps of preparing a mother stamper having a surface layer in which a grooved pattern is formed, forming a conductive layer on the mother stamper; and forming an electroplating layer on the conductive layer by electroplating the mother stamper in a plating solution consisting mainly of nickel sulfamate. In this stamper, Ni content in the electroplating layer from a boundary surface adjacent to the conductive layer to a depth of 10 μm increases continuously from the boundary surface toward an inner part of the electroplating layer.

With this construction of stamper according to the second aspect of the present invention, the Ni content in the electroplating layer from the boundary surface adjacent to the conductive layer to the depth of 10 μm increases continuously from the boundary surface toward the inner part of the electroplating layer, which leads to improved durability of this surface layer of the electroplating layer.

It is preferable that the electroplating layer contains at least one of Co, Zn, and B. Since the electroplating layer contains at least one of Co, Zn, and B whose content become lower as the current density increases, it is possible to properly adjust the Ni content.

It is also preferable that the Ni content in the electroplating layer from the boundary surface to the depth of 10 μm varies in a range of 85 to 99% by weight. Further, it is preferable that a total thickness of the conductive layer and the electroplating layer is in a range of 30 to 400 μm. Changing the weight percentage of the Ni content in the range of 85-99% causes the surface layer to have lower Ni content, which leads to microparticulated particles in the surface layer. This can improve pattern formation characteristics and thus pattern transferability as a result. Further, increase in the hardness leads to improved mechanical strength and improved durability of the stamper. Moreover, in the case where the total thickness of the conductive layer and the electroplating layer is in a range of 30 to 400 μm, it is possible to ensure both handlability as a stamper (or a master) and workability upon stamping. If the thickness is too thin, the handlability is deteriorated. On the contrary, if the thickness is too thick, it becomes difficult to carry out the stamping process.

According to a third aspect, the present invention is also applicable to a method of manufacturing a master for magnetic transfer, comprising the steps of preparing a mother stamper having a surface layer in which a grooved pattern is formed, forming a conductive layer on the mother stamper; and forming an electroplating layer on the conductive layer by electroplating the mother stamper in a plating solution consisting mainly of nickel sulfamate. In this manufacturing method, a current density is increased at a predetermined increasing rate at a start of electroplating.

According to a fourth aspect, the present invention is also applicable to a master for magnetic transfer, which is manufactured by the process comprising the steps of preparing a mother stamper having a surface layer in which a grooved pattern is formed, forming a conductive layer on the mother stamper, and forming an electroplating layer on the conductive layer by electroplating the mother stamper in a plating solution consisting mainly of nickel sulfamate. In this master, Ni content in the electroplating layer from a boundary surface adjacent to the conductive layer to a depth of 10 μm increases continuously from the boundary surface toward an inner part of the electroplating layer.

Herein, the master for magnetic transfer has a predetermined grooved pattern for writing a servo signal in a disc-shaped magnetic recording medium.

According to the third to fourth aspects of the present invention, the same advantages as the first and second aspects can be obtained.

According to the present invention, if only the current density is increased at a predetermined increasing rate at the start of electroplating, the content of impurities becomes higher at the surface layer of the electroplating layer that is adjacent to the conductive layer. This leads to simplification of the manufacturing process as well as to improve durability.

### BRIEF DESCRIPTION OF THE DRAWINGS

Other objects and aspects of the present invention will become more apparent by describing in detail illustrative, non-limiting embodiments thereof with reference to the accompanying drawings, in which:

FIG. 1 is a plan view of a mother stamper used for manufacturing an optical information recording medium;

FIG. 2 is an explanatory view illustrating the depth of a groove;

FIG. 3 is a sectional view illustrating the layered structure of an optical information recording medium manufactured from a stamper that is manufactured by the manufacturing method according to the present invention;

FIGS. 4A to 4E are views explaining a series of manufacturing processes for manufacturing a mother stamper;

FIGS. 5A to 5E are views explaining a series of manufacturing processes for manufacturing a stamper according to the present invention;

FIG. 6A is a graph showing a first example for controlling current density, FIG. 6B is a graph showing a second example for controlling current density, and FIG. 6C is a graph showing a third example for controlling current density;

FIGS. 7A and 7B are graphs showing experimental results of Example 1, in which

FIG. 7A is a graph showing the relation between Ni content and principal current, and FIG. 7B is a graph showing the relation between Zn content, Co content, B content and principal current; and

FIG. 8 is a graph showing an experimental result of Example 2, in which the relation between hardness and primary current is shown.

### DETAILED DESCRIPTION OF THE INVENTION

With reference the accompanying drawings, one preferred embodiment of the manufacturing method for a stamper for an optical information recording medium according to the present invention will be described in detail.

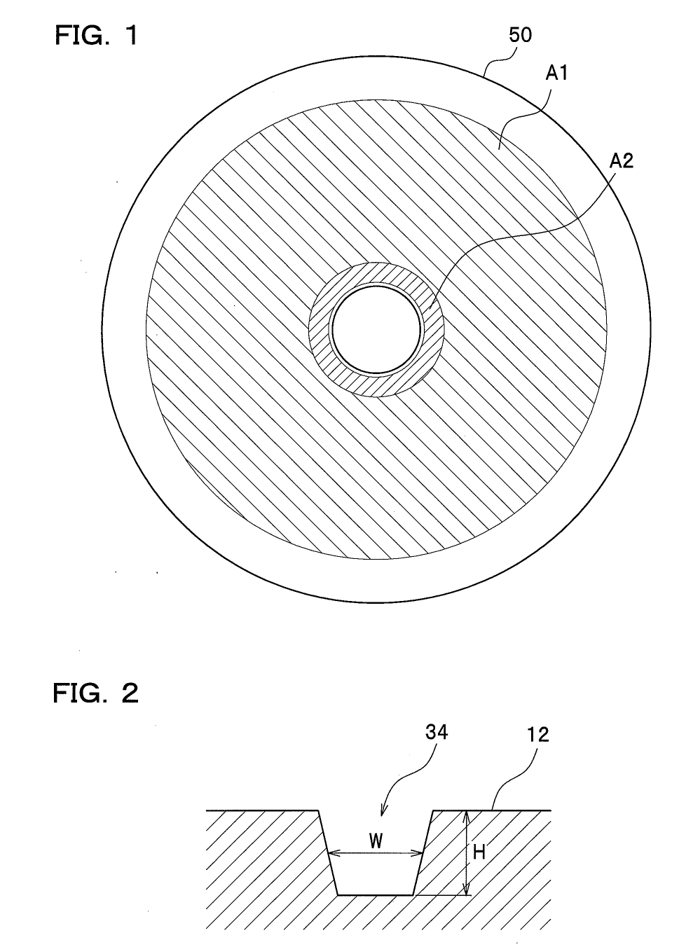

A stamper for an optical information recording medium to be manufactured by the manufacturing method according to the present invention is used for manufacturing an optical information recording medium with a dye recording layer which is rerecorded and/or read with a short-wavelength laser. For example, a currently advocated Blu-ray Disc includes a management information recording area, such as BCA (Burst Cutting Area) area, at an inner periphery of the optical information recording medium, at which information such as disc information is recorded. FIG. 1 is a plan view of a mother stamper used for manufacturing this optical information recording medium, in which hatchings indicate areas. As shown in FIG. 1, a disc-shaped mother stamper 50 includes a data recording area A1 in the shape of a donut in which a spiral-shaped first pre-groove (not shown) is formed. Provided inward of the data recording area A1 is the BCA area A2. The BCA area A2 also forms a spiral-shaped second pre-groove (not shown).

In the optical information recording medium manufactured using the mother stamper 50 (namely, the optical information recording medium manufactured using a stamper that is manufactured from the mother stamper 50), the BCA signal in the form of a bar code is recorded on the dye recording layer and/or the reflective layer using a laser light. It is necessary that the pre-groove (second pre-groove) is formed in the BCA area. The depth of the second pre-groove is preferably shallower than the pre-groove (first pre-groove) formed in the data recording area A1.

Next, description will be given of one embodiment of an optical information recording medium manufactured using the stamper that is manufactured by the manufacturing method according to the present invention.

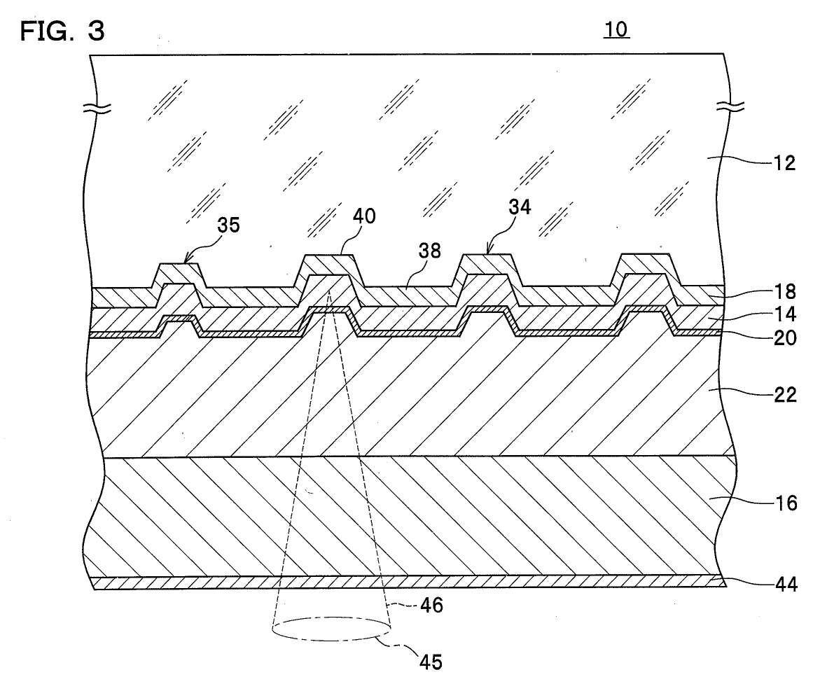

As shown in FIG. 3, the optical information recording medium 10 includes a substrate 12 with a thickness of 0.7-2 mm, a write-once dye recording layer 14, and a cover layer 16 with a thickness of 0.01-0.5 mm in this order. More specifically, a light-reflective layer 18, the write-once recording layer 14, a barrier layer 20, an adhesive layer 22, and the cover layer 16 are stacked in this order on the substrate 12. Substrate 12

As shown in FIG. 3, the substrate 12 for the optical information recording medium 10 includes a first pre-groove (guide groove) 34 and a second pre-groove 35. The track pitch, groove width, groove depth, and Wobble amplitude of the first and the second pre-grooves 34, are defined as below.

As shown in FIG. 2, the groove width indicates a value (half width) that is measured at a half of the depth H of the pre-groove and corresponding to the width W.

The first pre-groove 34 is provided with higher recording density than the pre-groove of CD-R and DVD-R media, so that the optical information recording medium 10 is suitable as a recording medium for a blue-violet laser, for example.

The second pre-groove 35 is slightly smaller in the groove width and the groove depth than the first pre-groove 34. In the case where the optical information recording medium 10 has a disc shape, the second pre-groove 35 is provided on an inner periphery side. The second pre-groove 35 is used as a BCA area, for example, for recording manufacturer data of the optical information recording medium 10, and other management information. The BCA area requires less reflectivity than the data recording area in terms of its signal characteristics and it is necessary to lower the reflectivity of the BCA area. Therefore, the groove depth of the BCA area is shallower than that of the data recording area.

The track pitch of the first pre-groove 34 is approximately 320 nm. However, it is possible to vary the track pitch when necessary in accordance with specifications of the optical information recording medium.

The groove width (half width) of the first pre-groove 34 is preferably in the range of 90-180 nm.

If the groove width of the first pre-groove 34 is less than 90 nm, the groove may not be transferred properly upon molding or the recording error rate may become higher. On the contrary, if the groove width of the first pre-groove 34 is more than 180 nm, a pit may extend upon recording, which results in cross talk or insufficient modulation degree.

The groove depth A of the first pre-groove 34 is not more than 60 nm, preferably in the range of 30-50 nm, and more preferably in the range of 35-45 nm. If the groove depth of the first pre-groove 34 is less than 5 nm, sufficient recording modulation degree can not be obtained. On the contrary, if the groove depth A of the first pre-groove 34 is more than 60 nm, the reflectivity may decrease considerably.

Further, it is preferable that the inclination angle of the groove of the first pre-groove 34 is 80 degrees at most, preferably not more than 70 degrees, more preferably not more than 60 degrees, and most preferably not more than 50 degrees. On the contrary, the lowest value of the inclination angle is preferably not less than 20 degrees, more preferably not less than 30 degrees, and most preferably not less than 40 degrees.

If the inclination angle of the groove of the first pre-groove 34 is less than 20 degrees, sufficient amplitude of the tracking error signal may not be obtained. On the contrary, if the inclination angle of the groove of the first pre-groove 34 is more than 80 degrees, it becomes difficult to mold (e.g., by injection molding) the substrate 12.

The groove depth B of the second pre-groove 35 is in the range of 5-30 nm, and more preferably in the range of 8-17 nm.

The groove width (half width) of the second pre-groove 35 is arbitrarily set in the range where the groove depth B of the second pre-groove 35 lies in the aforementioned range.

The preferable inclination angle of the groove of the second pre-groove 35 is substantially the same as that of the first pre-groove 34.

Any of the conventionally known materials for a substrate for the optical information recording medium may be selected as the substrate 12 for the optical information recording medium 10 according to the present invention.

Among the materials for the substrate, thermoplastic resin such as amorphous polyolefins and polycarbonates is preferable in terms of moisture resistance, dimensional stability, and low cost. Most preferably, polycarbonates are used.

When these kinds of resin are used, the substrate 12 is manufactured by injection molding.

The thickness of the substrate 12 is in the range of 0.7-2.0 mm, preferably in the range of 0.9-1.6 mm, and more preferably 1.0-1.3 mm.

On the surface of the substrate 12 at which the light-reflective layer 18 to be described later is provided, an undercoating layer is preferably formed in order to improve planarity and adhesive force of the optical information recording medium 10.

### Write-Once Recording Layer 14

According to one preferable embodiment, the write-once recording layer 14 of the optical information recording medium 10 is formed by preparing a coating liquid into which a dye, a binder and the like are dissolved in an appropriate solvent, followed by applying the coating liquid onto the substrate or the light-reflective layer 18 to be described later and drying the thus formed coating film. The write-once recording layer 14 may be either of a single-layered or multi-layered structure. In the case of the multi-layered structure, the coating liquid application process is carried out plural times.

The application process is carried out, for example, by spray coating method, spin coating method, dip coating method, roll coating method, blade coating method, doctor roll method, screen printing method, etc.

It is preferable that the thickness of the write-once recording layer 14 manufactured accordingly is not more than 300 nm, preferably not more than 250 nm, more preferably not more than 200 nm, and most preferably not more than 180 nm on the groove 38 (at the protrusions of the substrate 12). Further, it is preferable that the lowest value of the thickness is not less than 30 nm, preferably not less than 50 nm, more preferably not less than 70 nm, and most preferably not less than 90 nm.

It is preferable that the thickness of the write-once recording layer 14 is not more than 400 nm, more preferably not more than 300 nm, and most preferably not more than 250 nm on the land 40 (at the recess portions of the substrate 12). The lowest value of the thickness of the write-once recording layer 14 is preferably not less than 70 nm, more preferably not less than 90 nm, and most preferably not less than 110 nm.

Further, the ratio of the thickness t1 of the write-once recording layer 14 on the groove 38 to the thickness t2 of the write-once recording layer 14 on the land 40 (i.e., t1/t2) is not less than 0.4, preferably not less than 0.5, more preferably not less than 0.6, and most preferably not less than 0.7. Further, it is preferable that the highest value of t1/t2 is less than 1.0, preferably not more than 0.9, more preferably not more than 0.85, and most preferably not more than 0.8.

### Cover Layer 16

According to one preferred embodiment, the cover layer 16 of the optical information recording medium 10 is attached to the write-once recording layer 14 as described above or the barrier layer 20 to be described later by the adhesive layer 22 consisting of adhesive, pressure-sensitive adhesive, etc.

As long as it is a transparent film, any known materials may be used as the cover layer 16 for the optical information recording medium 10. However, polycarbonates, and acrylic resins such as polymethyl methacrylates; vinyl chloride resin such as polyvinyl chloride, and vinyl chloride copolymer; epoxy resin; amorphous polyolefins; polyesters; cellulose triacetate are preferable. Of these resins, use of polycarbonates or cellulose triacetate may be more preferable.

The term “transparent” indicates the transmissivity equal to or greater than 80% relative to the light used for recording and/or reading.

As long as the advantages of the present invention can be obtained, the cover layer 16 may contain various additives. For example, the cover layer 16 may contain a UV (ultraviolet) absorbing agent for blocking light whose wavelength is 400 nm or less and/or a dye for cutting light whose wavelength is 500 nm or more.

As surface properties of the cover layer 16, it is preferable that the surface roughness is not more than 5 nm at both two-dimensional surface roughness and three-dimensional surface roughness.

Further, in terms of collecting power of the light used for recording and reading, the double refraction of the cover layer 16 is preferably 10 nm or less.

The thickness of the cover layer 16 is defined when necessary based on the wavelength of the laser light 46 irradiated for recording and reading and/or the numerical aperture (NA) of the objective lens 45. However, in the optical information recording medium 10, the thickness of the cover layer 16 is preferably in the range of 0.01-0.5 mm, and more preferably in the range of 0.05-0.12 mm.

The total thickness of the cover layer 16 and the adhesive layer 22 is preferably in the range of 0.09-0.11 mm, and more preferably in the range of 0.095-0.105 mm.

A hard coat layer 44 (protection layer) may be provided at the light incident surface of the cover layer 16 so as to prevent the light incident surface from being damaged during the manufacture of the optical information recording medium 10.

Adhesive used for the adhesive layer 22 preferably includes, for example, UV curable resin, EB curable resin, heat curable resin, etc. Of these resins, use of the UV curable resin is most preferable.

In the case where the UV curable resin is used as the adhesive, the UV curable resin may be directly applied on the surface of the barrier layer 20 by a dispenser. Alternatively, the UV curable resin may be dissolved in an appropriate solvent such as methyl ethyl ketone or ethyl acetate to prepare a coating liquid, followed by applying the coating liquid on the surface of the barrier layer 20 using the dispenser. Further, in order to prevent a skew or distortion of the optical information recording medium 10, it is preferable that the UV curable resin which forms the adhesive layer 22 has a lower shrinkage upon curing. As one example of such UV curable resin, SD-640 manufactured by DAINIPPON INK & CHEMICALS, INCORPORATED is preferable.

The adhesive is applied on a joint surface, for example, consisting of the barrier layer 20 to a predetermined amount, and thereafter the cover layer 16 is put thereon. The adhesive is then extended evenly by spin coating between the joint surface and the cover layer 16 and is finally cured.

It is preferable that the thickness of the adhesive layer 22 consisting of the adhesive is in the range of 0.1-100 μm, more preferably in the range of 0.5-50 μm, and most preferably in the range of 10-30 μm.

As the pressure-sensitive adhesive used for the adhesive layer 22, acrylic adhesive, rubber based adhesive, or silicon based adhesive may be used. However, in terms of transparency and durability, acrylic adhesive is preferable.

A predetermined amount of the pressure-sensitive adhesive is evenly applied on a joint surface consisting of the barrier layer 20, and thereafter the cover layer 16 is put prior to curing. Alternatively, a predetermined amount of the pressure-sensitive adhesive may be evenly applied on one surface of the cover layer 16 to form a coating film, and thereafter the coating film is attached to the joint surface and is finally cured.

It is also possible to attach a commercially available pressure-sensitive adhesive film with a pressure-sensitive adhesive layer on the cover layer 16.

The thickness of the adhesive layer 22 consisting of the pressure-sensitive adhesive is preferably in the range of 0.1-100 μm, more preferably in the range of 0.5-50 μm, and most preferably in the range of 10-30 μm.

### Other Layers of Optical Information Recording Medium 10

According to a preferred embodiment, the optical information recording medium 10 may include other optional layers in addition to the aforementioned layers. Such other optional layers include, for example, a label layer formed on the reverse surface of the substrate 12 (i.e., the reverse surface relative to the surface on which the write-once recording layer 14 is formed) and having a predetermined image thereon, the light-reflective layer 18 to be described later provided between the substrate 12 and the write-once recording layer 14, the barrier layer 20 to be described later provided between the write-once recording layer 14 and the cover layer 16, an interface layer provided between the light-reflective layer 18 and the write-once recording layer 14, etc. The label layer is made of UV curable resin, heat curable resin, and thermally curable resin, for example.

These layers may be of a single-layered or a multi-layered structure.

### Light-Reflective Layer 18

In order to enhance the reflectivity to the laser light 46 or to improve the recording/reading characteristics, the optical information recording medium 10 preferably includes the light-reflective layer 18 between the substrate 12 and the write-once recording layer 14.

The light-reflective layer 18 is made of a light-reflective material whose reflectivity to the laser light 46 is high. The light-reflective layer 18 is formed on the substrate 12 by depositing the light-reflective material by vacuum evaporation, sputtering, or ion plating.

The thickness of the light-reflective layer 18 is generally in the range of 10-300 nm, and more preferably in the range of 50-200 nm.

The reflectivity is preferably not less than 70%.

The light-reflective layer 18 is made of a material including metal such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn, and Bi, semimetal, or stainless steel.

### Barrier Layer (Intermediate Layer) 20

The optical information recording medium 10 preferably forms the barrier layer 20 between the write-once recording layer 14 and the cover layer 16.

The barrier layer 20 is provided, for example, in order to improve the storage stability of the write-once recording layer 14, to improve adhesiveness between the write-once recording layer 14 and the cover layer 16, to adjust the reflectivity, or to adjust the heat conductivity.

As long as it allows transmission of the light used for recording and reading while providing the above properties, any known materials may be used as the barrier layer 20. However, in general, such materials have lower permeability for gas or moisture, and they are preferably dielectric materials.

Further, the barrier layer 20 is formed by vacuum coating such as vacuum evaporation, DC-sputtering, RF-sputtering, and ion plating. Of these methods, sputtering is more preferable, and RF sputtering is most preferable.

The thickness of the barrier layer 20 is preferably in the range of 1-200 nm, more preferably in the range of 2-100 nm, and most preferably in the range of 3-50 nm. Optical information recording method

A recording laser light 46 such as the laser light of a semiconductor laser is irradiated on the side of the cover layer 16 via an objective lens 45 whose numerical aperture (NA) is 0.85 for example while rotating the optical information recording medium 10 at a constant linear velocity (e.g., 0.5-10 m/sec) or at a constant angular velocity. When the laser light 46 is irradiated, the write-once recording layer 14 absorbs the laser light 46 so that the temperature of the write-once recording layer 14 locally elevates. This can create a physical or chemical change (e.g., formation of pits), which results in a change in optical characteristics by which information is recorded.

As the recording laser light 46, the laser light of the semiconductor laser whose oscillation wavelength is in the range of 390-450 nm is used. A preferable light source may be a blue-violet semiconductor laser light with the oscillation wavelength in the range of 390-415 nm, or a blue-violet SHG laser light with the central oscillation wavelength of 425 nm which is obtained by reducing to a half of the wavelength of an infrared semiconductor laser light with the central oscillation wavelength of 850 nm using a light guide element. Especially, it is preferable to use the blue-violet semiconductor laser light with the oscillation wavelength in the range of 390-415 nm in terms of recording density. Upon reading the information that has been recorded as previously described, the semiconductor laser light is irradiated on the side of the substrate or on the side of the protection layer while rotating the optical information recording medium 10 at the aforementioned constant linear velocity, and the reflected light is then detected.

The laser light 46 may be a laser light in near-infrared range (normally around the wavelength of 780 nm), a visible-laser light (in the range of 630-680 nm), or a laser light whose wavelength is not more than 530 nm (blue laser light in the 405 nm range). Of these, the visible-laser light (in the range of 630-680 nm) and the laser light whose wavelength is not more than 530 nm (blue laser light in the 405 nm range) are more preferable. Most preferably, the laser light 46 is the laser light whose wavelength is not more than 530 nm (blue laser light in the 405 nm range).

Next, description will be given of a manufacturing method for a stamper that is used for manufacturing the substrate 12 for the optical information recording medium 10 as described above. Also, description will be given of a manufacturing method for a mother stamper used for manufacturing such a stamper.

### Manufacturing Method for Mother Stamper

Mother stamper is a mold for manufacturing a stamper. The mother stamper is manufactured by the following processes.

### Photoresist Layer Formation Process

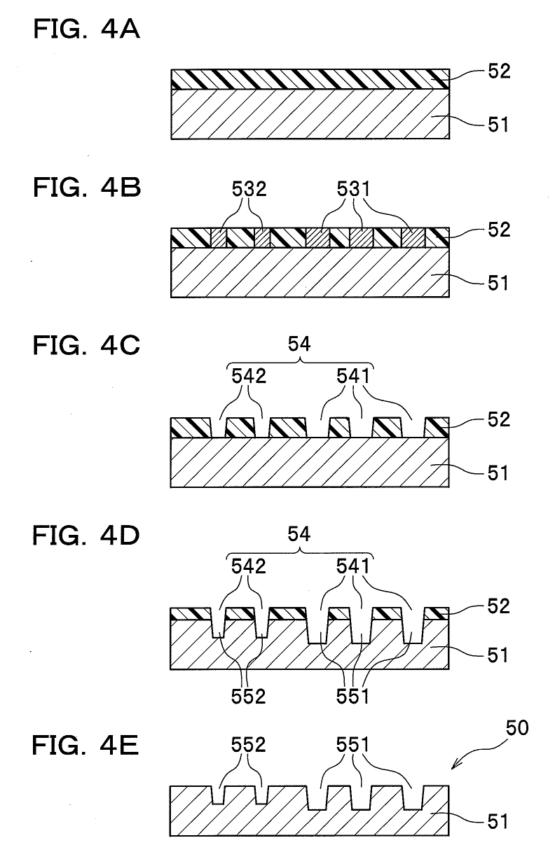

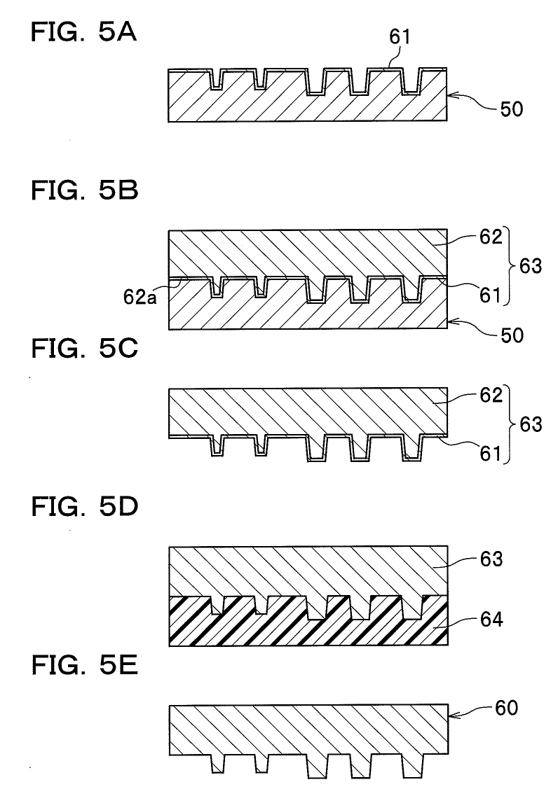

At first, a silicon wafer 51 (e.g., an 8 inch dummy wafer manufactured by Fujimi Fine Technology Inc.) is prepared as a silicon-containing substrate with a smoothed surface. An undercoating is applied to form a closely contact layer on the silicon wafer 51. As shown in FIG. 4A, an electron beam resist liquid is applied on the silicon wafer 51 by spin coating to form a photoresist layer 52 which is then baked. FEP-171 manufactured by FUJIFILM Electronic Materials Co., Ltd. may be used as the electron beam resist liquid. The thickness of the photoresist layer 52 is 100 nm.

### Electron Beam Irradiation Process

As shown in FIG. 4B, electron beam is irradiated at a predetermined pattern on the photoresist layer 52 using an electron beam exposure apparatus equipped with a highly accurate rotary stage. The electron beam exposure apparatus modulates the electron beam in accordance with various signals including an address, etc. It is preferable that the drawing pattern is made by a first exposure line 531 associated with the first pre-groove 34 and a second exposure line 532 associated with the second pre-groove 35 and being thinner than the first exposure line 531.

The widths of lines drawn by the electron beam upon exposure are preferably in the range of 100-180 nm, and more preferably in the range of 120-140 nm. For example, it is preferable that the first exposure line 531 (in the data recording area A1) is 140 nm (width) and the second exposure line 532 (in the BCA area A2) is 100 nm (width). The address in the first pre-groove 34 or the second pre-groove 35 may be recorded by modulating the first exposure line 531 or the second exposure line 532 to have a wave-like pattern. In this instance, the amplitude of the wave (wobble width) is preferably in the range of 14-24 nm, and more preferably in the range of 15-17 nm. The electron beam for drawing the first exposure line 531 and the second exposure line 532 may be determined by the accelerating voltage of 50 kV. The first exposure line 531 and the second exposure line 532 may be a line of aggregated dots.

### Development Process

As shown in FIG. 4C, the photoresist layer 52 is then developed with a developer to remove the exposed area (the first exposure line 531 and the second exposure line 532). By this process, an opening 54 (541, 542) with a predetermined pattern is formed in the photoresist layer 52. To be more specific, a first opening 541 is formed associated with the first exposure line 531, and a second opening 542 is formed associated with the second exposure line 532 that is narrower than the first exposure line 531. FHD-5 manufactured by FUJIFILM Electronic Materials Co., Ltd. may be used as the developer.

### Etching Process

As shown in FIG. 4D, an etching process is carried out by directing the etching gas onto the silicon wafer 51 via the opening 54 of the photoresist layer 52, so that the silicon wafer 51 is locally removed to a predetermined depth, preferably in the range of 30-50 nm, and most preferably about 40 nm. In this etching process, anisotropic etching is preferable in order to minimize undercutting (i.e., etching in the direction perpendicular to the depth direction). Reactive ion etching (RIE) in which an etching gas tends to travel in a straight line may be used as the anisotropic etching.

By this etching process, the silicon wafer 51 is made to have a wider first groove 551 associated with the first opening 541 and a narrower second groove 552 associated with the second opening 542. Further, the depth of the first groove 551 and the depth of the second groove 552 are different in accordance with the size (width) of the opening 54. To be more specific, the depth A of the first groove 551 is not more than 60 nm but is deeper than the second groove 552. The depth A of the first groove 551 is preferably in the range of 30-50 nm, and more preferably in the range of 35-45 nm. The depth B of the second groove 552 is shallower than the first groove 551 and is preferably in the range of 5-30 nm, and more preferably in the range of 8-17 nm. In other words, the first groove 551 and the second groove 552 are formed to satisfy the formula: A>B.

The angle made by the side wall of the respective first groove 551 and the second groove 552 with respect to the surface of the silicon wafer 51 is preferably in the range of 40-80 degrees, and more preferably in the range of 55-65 degrees.

E620 manufactured by Panasonic Factory Solutions Co., Ltd. may be used for reactive ion etching (RIE). The etching gas may be CHF₃.

The angle of the side wall can be controlled by the reaction product of Si and the etching gas. In this regard, tests are carried out by changing states of the reaction product, for example, with the use of a gas by which yield of the reaction product differs or by changing the flow rate of the gas, pressure, etc. so that the side wall of the groove thus formed has a desired angle.

### Resist Removal Process

The photoresist layer 52 remaining after the etching process is removed. Removal of the photoresist layer 52 is carried out by a dry process such as ashing in which oxygen plasma is irradiated to remove organic matters. Removal of the photoresist layer 52 may be carried out by a wet process such as using a resist stripping agent.

As shown in FIG. 4E, a mother stamper 50 is manufactured by the manufacturing method as described above.

Therefore, the mother stamper 50 according to the above manufacturing method provides two different kinds of highly accurately and extremely fine grooves (i.e., the first groove 551 and the second groove 552) each having a different depth to the other.

### Manufacturing Method for Stamper

Description will be given of a method of manufacturing a stamper from a mother stamper.

### Thin Film Forming Process

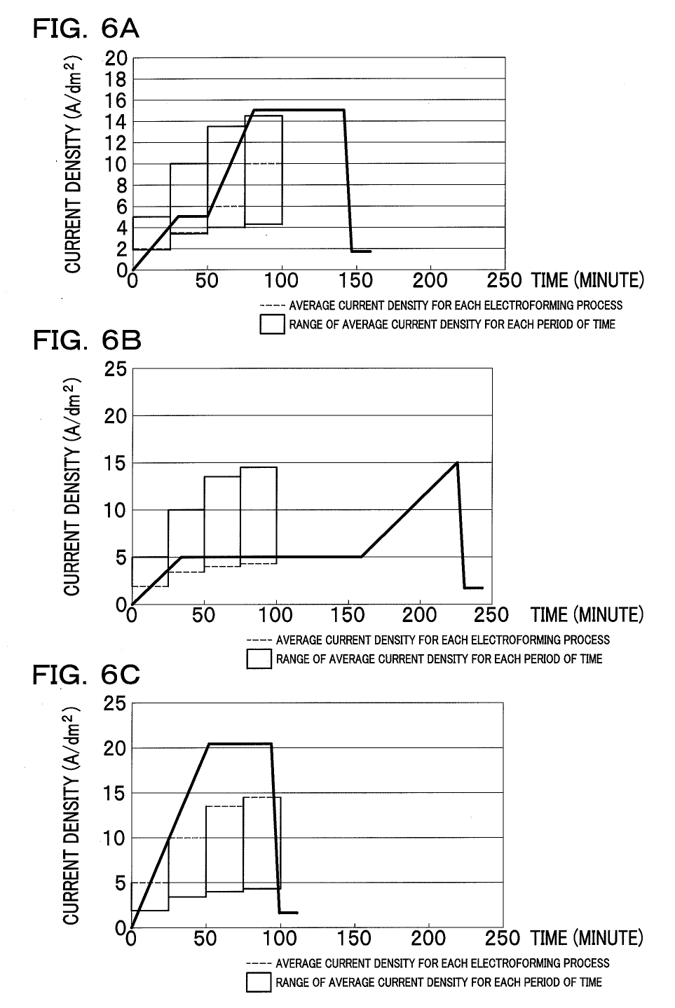

When a stamper 60 (see FIG. 5E) is manufactured from the mother stamper 50, electroplating is firstly applied on the mother stamper 50 to prepare a metal plate having a surface to which the surface pattern of the mother stamper 50 is reversely transferred.

As seen in FIG. 5A, a pretreatment for electroplating the mother stamper 50 is carried out so that a metal thin film 61 having a thickness of several tens of nanometers, for example, about 18 nm thickness is formed as a conductive layer by sputtering or other methods. Therefore, the surface of the silicon wafer 51 has electrical conductivity. For example, Ni may be used as a material for the metal thin film 61.

### Plating Process

The mother stamper 50 with the metal thin film 61 is dipped into a plating solution which consists mainly of nickel sulfamate and whose temperature is 55° C. Next, as seen in FIG. 5B, electroplating is applied to form an electroplating layer 62 having a thickness of approximately 295±5 μm. According to this preferred embodiment, the electroplating layer 62 contains Ni (nickel), Co (cobalt), Zn (zinc), and B (boron). During the plating process, the current density of an electric current applied for starting the electroplating is increased manually by an operator or under control of a control device at a predetermined increasing rate. The increasing rate is determined based on TABLE 1 below.

TABLE 1

| Time for applying | Minimum average | Maximum average current |
|---|---|---|
| Electroplating | current density (A/dm²) | density (A/dm²) |
| 0-25 minutes | 1.9 | 5.0 |
| 0-50 minutes | 3.4 | 10.0 |
| 0-75 minutes | 4.0 | 13.5 |
| 0-100 minutes | 4.3 | 14.5 |

Description will be given of how to determine the increasing rate.

As seen in TABLE 1 and FIGS. 6A to 6C, the increasing rate is determined to have a slope such that the average current density for a predetermined period of the electroplating process is in a predetermined range. To be more specific, the gradient (rate) of increase (i.e., positive slope) from the start of the electroplating (0 minute) until elapse of 25 minutes is determined such that the average current density from the start of the electroplating (0 minute) until elapse of 25 minutes is in the range of 1.9-5.0 A/dm². Further, the gradient (rate) of increase (i.e., positive slope) from 25 to 50 minutes is determined such that the average current density from the start of the electroplating (0 minute) until elapse of 50 minutes is in the range of 3.4-10 A/dm², the gradient (rate) of increase (i.e., positive slope) from 50 to 75 minutes is determined such that the average current density from the start of the electroplating (0 minute) until elapse of 75 minutes is in the range of 4.0-13.5 A/dm², and the gradient (rate) of increase (i.e., positive slope) from 75 to 100 minutes is determined such that the average current density from the start of the electroplating (0 minute) until elapse of 100 minutes is in the range of 4.3 to 14.5 A/dm².

According to a first example for controlling the current density as shown in FIG. 6A, there is shown an example which makes it possible to improve the durability of the surface layer of the electroplating layer 62 adjacent to the metal thin film 61 (i.e., the surface layer of the stamper 60) as well as to improve the productivity. According to a second example for controlling the current density as shown in FIG. 6B, there is shown an example which places prime importance on an improvement in durability of the surface layer of the stamper 60. Further, according to a third example for controlling the current density as shown in FIG. 6C, there is shown an example which emphasizes an improvement in the productivity.

If the current density is gradually increased after the start of electroplating with the increasing rate determined as above, the Ni content in the electroplating layer 62 continuously increases from the surface 62a of the electroplating layer 62 adjacent to the metal thin film 61 toward the inner part of the electroplating layer 62. In other words, the content of other elements (impurities) except for Ni becomes higher near the surface 62a of the electroplating layer 62. This fact has been confirmed by the inventor through experiments, which will be described later in various Examples. It is to be noted that the continuous increase in the Ni content in the electroplating layer 62 should be present at least in an area from the boundary surface (i.e., the boundary between the electroplating layer 62 and the metal thin film 61) to the depth of 10 μm.

As described above, if the Ni content in the electroplating layer 62 from the boundary surface 62a adjacent to the metal thin film 61 to the depth of 10 μm increases continuously with distance from the surface 62a of the electroplating layer 62, it is preferable that the Ni content is controlled to vary in the range of 85-99% by weight. In order to make the Ni content change in this range, the current density is controlled by the increasing rate that is determined by the method as described above. Further, it is preferable that the thickness of the metal plate 63 consisting of the metal thin film 61 and the electroplating layer 62 is in the range of 30-400 μm. Changing the weight percentage of the Ni content in the range of 85-99% causes the surface layer to have lower Ni content, which leads to microparticulated particles in the surface layer. This can improve pattern formation characteristics and thus pattern transferability as a result. Further, increase in the hardness leads to improved mechanical strength and improved durability of the stamper. Moreover, in the case where the thickness of the metal plate 63 is in the range of 30-400 μm, it is possible to ensure as a stamper (or a master) both handlability and workability upon stamping. If the thickness of the thick metal film is too thin, the handlability is deteriorated. On the contrary, if the thickness of the thick metal film is too thick, it becomes difficult to carry out the stamping process.

### Stripping Process

As seen in FIG. 5C, the metal plate 63 consisting of the metal thin film 61 and the electroplating layer 62 is stripped off (removed) from the mother stamper 50. During the stripping process, the mother stamper 50 is dipped into a liquid such as pure water (pure hot water), the temperature of which is substantially the same as that of the plating solution used in the plating process, for instance, at a temperature within ±5° C. from the temperature of the plating solution. It is preferable that the pure water is introduced into a space between the metal plate 63 and the mother stamper 50 while washing out the plating solution.

### Stamping Process

The obtained metal plate 63 is stamped out using a pressing machine, and thereafter the inner peripheral portion and the outer peripheral portion of the stamped metal plate are subject to machining. The punch of the pressing machine has 138 mm outer diameter and 22 mm inner diameter.

The surface of the machined metal plate 63 where the grooved pattern is formed is applied with a protecting agent, such as SILITECT manufactured by Hiro-Tec Co., Ltd., and then dried to form a protective film 64 thereon as shown in FIG. 5D.

The reverse surface of the metal plate 63 is then ground and smoothed using a rotary polishing device. It is preferable that the surface roughness Ra of the reverse surface of the metal plate 63 is approximately in the range of 0.5-1 μm.

Finally, as seen in FIG. 5E, the protective film 64 is stripped off by ashing in which oxygen plasma is irradiated, so that the stamper 60 is obtained.

### Inspection Process

After the stamper 60 is obtained, a cover layer which is similar to the cover layer 16 of the optical information recording medium 10 is attached to the surface of the stamper 60 to protect the surface thereof. The stamper 60 is then set in an inspection apparatus which makes use of an electrical signal, so as to check the quality of the grooves of the stamper 60.

The inspection apparatus may be any known apparatus and inspection is carried out, for example, to check reflectivity and variation in reflectivity of the grooves, to check push-pull signal (Wobble form), to measure address error rate using a signal detector, and to inspect foreign matters using an inspection machine.

Accordingly, the stamper 60 to which the grooved pattern formed in the surface of the mother stamper 50 has been transferred is obtained. The mother stamper 50 from which the metal plate 63 has been removed is washed with cleaning liquid such as strong acid. The above described processes, such as the thin film forming process, the plating process, and the stripping process are repeated so that a plurality of stampers 60 are produced from a single mother stamper.

Since the stamper 60 is produced by directly transferring the grooved pattern from the mother stamper 50, it is possible to highly accurately form the desired fine grooved pattern on the stamper 60.

According to the above preferred embodiment, if only the current density is increased by a predetermined increasing rate at the start of electroplating, the content of impurities becomes higher at the surface layer of the electroplating layer 62. This leads to simplification of the manufacturing process as well as to improve durability. Further, since the content of impurities becomes higher at the surface layer of the electroplating layer 62, flatness and durability of the grooved pattern of the stamper 60 can also be improved.

Further, it is possible to properly adjust the Ni content (content of impurities) because the electroplating layer 62 contains at least one of Co, Zn, and B whose content become lower as the current density increases.

Although the present invention has been described with reference to the above specific embodiment, the present invention is not limited to this specific embodiment and various changes and modifications may be made without departing from the scope of the attached claims.

Although in the above preferred embodiment the electroplating layer 62 contains Co, Zn, and B, the present invention is not limited to this specific embodiment and any known impurities may be included in the electroplating layer 62. However, in order to appropriately control the Ni content, it is preferable that the electroplating layer 62 contains at least one of Co, Zn, and B.

According to the above embodiment, after the electroplating layer 62 is formed from the boundary surface to the depth of 10 μm, the current density may be controlled in any manner. However, it is preferable that the increasing rate of the current density is increased after the surface layer of the electroplating layer 62 is formed. This makes it possible to improve the productivity.

According to the above embodiment, the present invention is adapted to a stamper for the optical information recording medium 10 and a method of manufacturing the stamper. However, the present invention may be adapted to a master for magnetic transfer and a method of manufacturing such a master.

The present invention may be adapted to an imprint mold and a manufacturing method thereof used for manufacturing a DTM (discrete track media) or a BPM (bit patterned media).

### EXAMPLES

Description will be given of examples for the above preferred embodiment. To be more specific, Example 1 is an experiment for studying the relation between content of each component such as Ni and primary current. Example 2 is an experiment for studying the relation between hardness of the surface layer of the electroplating layer 62 at the depth of 10 μm from the boundary surface and primary current.

### Example 1

Conditions of the experiment for Example 1 are as follows.

(1) Plating solution:

Aqueous nickel sulfamate solution containing 600 g/l of Ni(SO₃NH₂)₂.4H₂O *¹

25-35 g/l of boric acid *²

0.15 g/l of sodium lauryl sulfate *³

*¹ Prepared by diluting Nickel sulfamate solution NS-160 manufactured by Showa Chemical Co., Ltd. with ultrapure water

### *² Manufactured by Wako Pure Chemical Industries, Ltd.

### *³ Manufactured by Showa Chemical Co., Ltd.

(2) Temperature of the plating solution: 55° C.
(3) Increasing rate of current density: 0.34 A/dm² min (34.2 A/m² min)

Under the above conditions, the current density was increased for a predetermined time at the above increasing rate, and thereafter the current density was maintained for a predetermined time at a predetermined current density (maximum value), so that the electroplating layer was obtained. In this example, three patterns were prepared for the maximum value of the current density, namely, 1.7 A/dm² (1.7×10² A/m²), 3.4 A/dm² (3.4×10² A/m²), and 6.8 A/dm² (6.8×10² A/m²). The content of each component was examined when the maximum value of the current density was at 1.7 A/dm², 3.4 A/dm², and 6.8 A/dm², respectively.

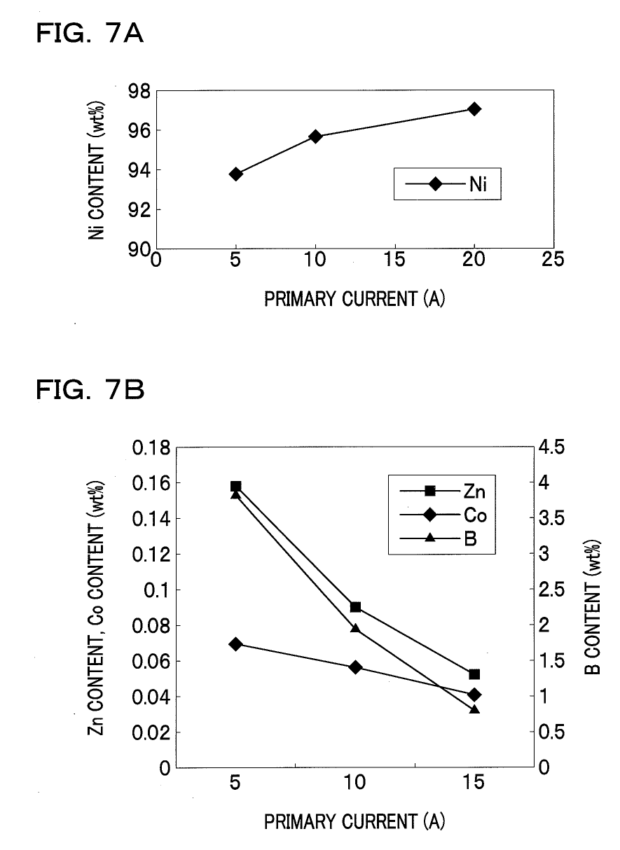

The content was examined by XRF (X-Ray Fluorescence) analysis method, and XRF-1700 manufactured by Shimadzu Corporation was used. Accordingly, experimental results as shown in TABLE 2 and FIGS. 7A and 7B were obtained. Herein, TABLE 2 shows the content (wt %; weight percent) of Ni, Zn, Co, and B contained in each of the electroplating layers that was obtained by electroplating using the three different patterns of current density.

TABLE 2

| | Current Density | | |
|---|---|---|---|
| | (A/dm²) | | |
| | 1.7 | 3.4 | 6.8 |
| Ni Content (weight percent) | 93.77 | 95.66 | 97.03 |
| Zn content (weight percent) | 0.16 | 0.09 | 0.05 |
| Co content (weight percent) | 0.07 | 0.06 | 0.04 |
| B content (weight percent) | 3.82 | 1.94 | 0.80 |

It should be noted that in FIGS. 7A and 7B the current density of 1.7 A/dm² corresponds to the primary current of 5 A, the current density of 3.4 A/dm² corresponds to the primary current of 10 A, and the current density of 6.8 A/dm² corresponds to the primary current of 20 A.

As seen in TABLE 2 and FIG. 7A, the experimental result of Example 1 shows that the Ni content increases as the current density increases. Also, as seen in TABLE 2 and FIG. 7B, the experimental result of Example 1 shows that the Zn content, the Co content, and the B content decrease as the current density increases. In view of these results, it is proved that if a film is formed with a low electric current, the Ni content becomes lower while the Zn content, the Co content, and the B content become higher.

### Example 2

Conditions of the experiment for Example 2 are as follows.

(1) Plating solution:

Aqueous nickel sulfamate solution containing 600 g/l of Ni(SO₃NH₂)₂.4H₂O *¹

25-35 g/l of boric acid *²

0.15 g/l of sodium lauryl sulfate *³

*¹ Prepared by diluting Nickel sulfamate solution NS-160 manufactured by Showa Chemical Co., Ltd. with ultrapure water

### *² Manufactured by Wako Pure Chemical Industries, Ltd.

### *³ Manufactured by Showa Chemical Co., Ltd.

(2) Temperature of the plating solution: 55° C.
(3) Increasing rate of current density: 0.57 A/dm²min (57.1 A/m²min)
(4) Hardness tester: NMT-30 (Vickers hardness tester) manufactured by Matsuzawa Co., Ltd.

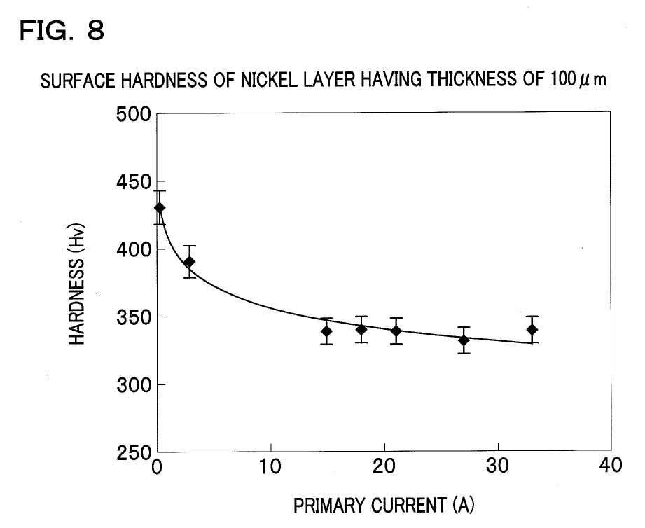

Under the above conditions, the current density was increased for a predetermined time at the above increasing rate, and thereafter the current density was maintained for a predetermined time at a predetermined current density (maximum value), so that the electroplating layer having a thickness of 100 μm was obtained. In this example, seven patterns were prepared for the maximum value of the current density, namely, 0.14 A/dm², 1.02 A/dm², 5.12 A/dm², 6.14 A/dm², 7.17 A/dm², 9.22 A/dm², and 11.26 A/dm². Seven surface hardness values of the electroplating layer that were formed in accordance with these current density values were examined using the hardness tester. The obtained experimental result was shown in FIG. 8. In FIG. 8, the abscissa axis of the graph indicates electric current instead of current density. However, it is possible to convert electric current values of this graph into current density values by dividing the electric current values by 2.93 dm² that is the surface area of the conductive layer (thin metal layer 61).

As seen in FIG. 8, the experimental result of Example 2 shows that the film formed by a lower electric current has a higher hardness, and the hardness of the film becomes lower as the electric current becomes higher. In other words, it was confirmed that the hardness of the film becomes lower with distance from the surface of the electroplating layer. In view of this result and the above experimental result of Example 1, it is proved that if the content of impurities such as Zn, Co, and B becomes higher, the hardness of the film increases accordingly.

What is claimed is:

1. A method of manufacturing a stamper for an optical information recording medium, comprising the steps of:
preparing a mother stamper having a surface layer in which a grooved pattern is formed;
forming a conductive layer on the mother stamper; and
forming an electroplating layer on the conductive layer by electroplating the mother stamper in a plating solution consisting mainly of nickel sulfamate,
wherein a current density is increased at a predetermined increasing rate at a start of electroplating.

2. The method according to claim 1, wherein the predetermined increasing rate is determined to have a slope such that an average current density from the start of the electroplating until elapse of 25 minutes is in a range of 1.9 to 5.0 A/dm².

3. The method according to claim 2, wherein the predetermined increasing rate is determined to have a slope such that an average current density from the start of the electroplating until elapse of 50 minutes is in a range of 3.4 to 10 A/dm², an average current density from the start of the electroplating until elapse of 75 minutes is in a range of 4.0 to 13.5 A/dm², and an average current density from the start of the electroplating until elapse of 100 minutes is in a range of 4.3 to 14.5 A/dm².

4. A stamper for an optical information recording medium, which is manufactured by the process comprising the steps of:
preparing a mother stamper having a surface layer in which a grooved pattern is formed;
forming a conductive layer on the mother stamper; and
forming an electroplating layer on the conductive layer by electroplating the mother stamper in a plating solution consisting mainly of nickel sulfamate,
wherein Ni content in the electroplating layer from a boundary surface adjacent to the conductive layer to a depth of 10 μm increases continuously from the boundary surface toward an inner part of the electroplating layer.

5. The stamper according to claim 4, wherein the electroplating layer contains at least one of Co, Zn, and B.

6. The stamper according to claim 4, wherein the Ni content in the electroplating layer from the boundary surface to the depth of 10 μm varies in a range of 85 to 99% by weight.

7. The stamper according to claim 4, wherein a total thickness of the conductive layer and the electroplating layer is in a range of 30 to 400 μm.

8. A method of manufacturing a master for magnetic transfer, comprising the steps of:
preparing a mother stamper having a surface layer in which a grooved pattern is formed;
forming a conductive layer on the mother stamper; and
forming an electroplating layer on the conductive layer by electroplating the mother stamper in a plating solution consisting mainly of nickel sulfamate,
wherein a current density is increased at a predetermined increasing rate at a start of electroplating.

9. The method according to claim 8, wherein the predetermined increasing rate is determined to have a slope such that an average current density from the start of the electroplating until elapse of 25 minutes is in a range of 1.9 to 5.0 A/dm².

10. The method according to claim 9, wherein the predetermined increasing rate is determined to have a slope such that an average current density from the start of the electroplating until elapse of 50 minutes is in a range of 3.4 to 10 A/dm², an average current density from the start of the electroplating until elapse of 75 minutes is in a range of 4.0 to 13.5 A/dm², and an average current density from the start of the electroplating until elapse of 100 minutes is in a range of 4.3 to 14.5 A/dm².

11. A master for magnetic transfer, which is manufactured by the process comprising the steps of:
preparing a mother stamper having a surface layer in which a grooved pattern is formed;
forming a conductive layer on the mother stamper; and
forming an electroplating layer on the conductive layer by electroplating the mother stamper in a plating solution consisting mainly of nickel sulfamate,
wherein Ni content in the electroplating layer from a boundary surface adjacent to the conductive layer to a depth of 10 μm increases continuously from the boundary surface toward an inner part of the electroplating layer.

12. The master according to claim 11, wherein the electroplating layer contains at least one of Co, Zn, and B.

13. The master according to claim 11, wherein the Ni content in the electroplating layer from the boundary surface to the depth of 10 μm varies in a range of 85 to 99% by weight.

14. The master according to claim 11, wherein a total thickness of the conductive layer and the electroplating layer is in a range of 30 to 400 μm.
